(19) United States
(12) Patent Application Publication
(10) Pub. No.: US 2021/0340963 A1
(43) Pub. Date: Nov. 4, 2021

(54) ICE DETECTION METHOD AND SYSTEM FOR A WIND TURBINE

(71) Applicant: Siemens Gamesa Renewable Energy Innovation & Technology S.L., Sarriguren (ES)

(72) Inventors: Almudena Muñoz Babiano, Madrid (ES); Arturo Santillán León, Madrid (ES)

(21) Appl. No.: 17/277,799

(22) PCT Filed: Aug. 19, 2019
(86) PCT No.: PCT/EP2019/072133

§ 371 Date: Mar. 19, 2021

(30) Foreign Application Priority Data
Sep. 19, 2018 (ES) 201800209

(51) Int. Cl. F03D 80/40; F03D 17/00

(52) U.S. Cl. CPC F03D 80/40; F03D 17/00

(57) ABSTRACT

A system for detecting ice on a wind turbine with a plurality of blades and a generator is provided. The temperature, humidity, and angular speed of the generator are measured in the method. The method includes processing said velocity to obtain the frequency spectrum; identifying a frequency band associated with the frequency characteristic of the blade in said spectrum; applying a Kalman filter on the band to identify the instantaneous vibration frequency; comparing the instantaneous frequency with a reference frequency corresponding to the natural frequency without ice; determining the power produced by the wind turbine, estimating the producible power, comparing both powers, and determining the presence of ice if the instantaneous frequency and reference frequency are different, if the measured power is less than the estimated power, and if the temperature and humidity tend to cause icing.

### CROSS-REFERENCE TO RELATED APPLICATIONS

This application is a national stage entry of PCT Application No. PCT/EP2019/072133 having a filing date of Aug. 19, 2019, which claims priority to Spanish Patent Application No. 201800209, having a filing date of Sep. 19, 2018, the entire contents of which are hereby incorporated by reference.

### FIELD OF TECHNOLOGY

The following relates to methods and systems for detecting ice on wind turbines.

### BACKGROUND

The presence of wind farms in cold areas makes it necessary to implement systems and methods which are capable of detecting anomalies in the power curve associated with icing or frosting on wind turbines.

Ice build-up on wind turbines entails a serious problem in cold climate areas that reduces energy production and also shortens the estimated service life of the main components in wind turbines. These components can be affected by different types of ice, such as frost, sub-cooled rain, wet snow, etc.

Furthermore, ice build-up is not a problem that only occurs in cold climates as it can happen under many different conditions. Ice can be found in coastal regions, mainly at high latitudes, and also in mountainous terrain. Icing, which occurs when the base of the clouds is located at a height or altitude lower than that of the center or nacelle of the wind turbine, constitutes the main problem in mountainous regions or regions close to mountaintops. Said event is referred to as in-cloud icing. Snowfall is another known cause of icing. A common factor in both cases usually consists of cloudy conditions.

Known standards, such as the ISO 12494 standard, define several types of ice and the weather conditions necessary their formation. The empirical variables include, among others, wind speed and direction, the temperature, and the length of time the cloud contacts the wind turbine. These systems typically use hygrometers based on the principle that the in-cloud water vapor content is very close to or higher than the saturation vapor pressure. This means that the relative humidity is generally higher than 95%. However, said systems are not entirely reliable. In coastal regions and offshore wind farms, the values of relative humidity may be high at all times, even without the presence of any cloud. One of such systems is described in US2005276696A1, which discloses a method for detecting ice on a rotor blade that includes monitoring weather conditions and the physical characteristics of the turbine which may cause mass imbalance between the rotor blades.

Another problem of systems of this type lies in the hygrometer itself If calibration is performed for a saturation vapor pressure value when said water is in liquid form, this can result in an incorrect measurement of the relative humidity when the temperature is below 0° C.

EP2505831A2 belonging to the applicant discloses a system and method for detecting ice on wind turbines that do not have these drawbacks. To that end, the solution disclosed in said document proposes measuring the direct solar radiation received by the corresponding wind turbine by means of a solar radiation sensor, and the measured value is compared with a theoretical radiation curve, wherein the mean values on a cloudy day are clearly below the theoretical curves.

### SUMMARY

An aspect relates to a new ice detection method and system for a wind turbine.

Another aspect of the present invention relates to an ice detection method for a wind turbine, the wind turbine comprising a plurality of blades and a generator. Ambient temperature and humidity are measured in the method, and the following steps are furthermore carried out in said method in a dynamic and recurrent manner (for at least one blade):
measuring the angular speed of the generator of the wind turbine,
processing said angular speed to obtain the frequency spectrum thereof,
identifying a frequency band associated with the frequency characteristic of the blade in said frequency spectrum,
applying a Kalman filter (or a Kalman algorithm) on said frequency band to identify the instantaneous vibration frequency of said blade,
comparing said identified instantaneous frequency with a reference frequency that has been previously stored and corresponds with the frequency of the blade when there is no ice thereon, and
determining the presence of ice on said blade if the identified instantaneous frequency differs from the reference frequency and if the measured temperature and humidity tend to cause icing.

These steps are carried out in a cyclical manner and at all times.

The presence or the absence of ice is determined when the difference between the identified instantaneous frequency and the reference frequency is greater than a predetermined threshold. The value of the threshold is determined by the plant controller or the manufacturer, and it can be performed based on previous experiences, for example.

The amount of ice built up on a blade increases blade rigidity, causing variations in its vibration frequency. So, by identifying the instantaneous frequency of the blade (its natural frequency at that time), this instantaneous frequency can be compared with the natural frequency of the blade in the absence of ice (the reference frequency), where any variation between the identified instantaneous frequency and the reference frequency can be detected. This variation is indicative of the possibility of there being ice on the blade, an event which can be confirmed depending on the temperature and humidity at that time. The environmental conditions (temperature and humidity) required for the generation of ice are already known, so if these conditions are detected along with a variation in the identified instantaneous frequency with respect to the reference frequency, the presence of ice on the blade can be determined without any risk of error (or with a high percentage of certainty, compared with current systems).

The identification is performed without having to add additional elements as it is a method that is implemented in the control algorithm of the wind turbine at the software level, since the sensors or detectors required for carrying out the method are present in all conventional wind turbines. This allows using this method in a simple and non-intrusive manner not only in new wind turbines, but also in those wind turbines that have already been installed by simply updating the software, without an additional increase in cost, even with the possibility of remotely charging same.

The implementation of the method would make the detection of ice on blades considerably more reliable as the natural frequencies of the blades do not change unless their physical properties (among them, rigidity, which would be directly related to the presence of ice) change.

The method allows detecting ice in real time without a significant amount of ice having to build up on the wind turbine, where strategies for operating with ice can be activated immediately and/or to apply the required corrective actions, which allows increasing the availability of the wind turbine and reducing the risk of malfunction or even deterioration of the wind turbine.

Another aspect of the present invention relates to an ice detection system for a wind turbine. The system is adapted for supporting the method of the first aspect of the present invention according to any of the embodiments thereof, the same advantages as those described for the method thereby being obtained in the system.

These and other advantages and features of the embodiment of the present invention will become evident in view of the drawings and the detailed description of the present invention.

### BRIEF DESCRIPTION

Some of the embodiments will be described in detail, with reference to the following figures, wherein like designations denote like members, wherein:

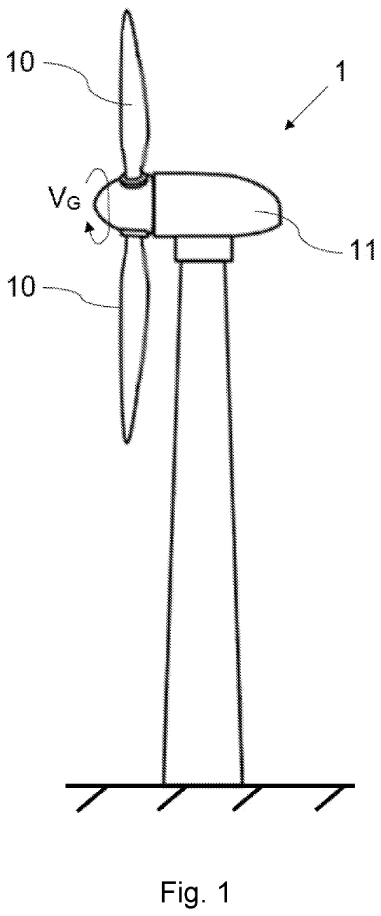

FIG. 1 depicts a wind turbine.

### DETAILED DESCRIPTION

A first aspect of the present invention relates to an ice detection method for a wind turbine 1 like the one shown by way of example in FIG. 1, which comprises a plurality of blades 10 and a generator 11 with a rotor. The method is adapted for being implemented on a blade 10, and it is adapted for being implemented on each of the blades 10 of the wind turbine 1 in an independent manner, where the presence or absence of ice can thereby be detected on all the blades 10 in an independent manner.

In normal operation, the blades 10 rotate at a given speed, causing the rotation of the generator 11, such that said generator 11 comprises an angular speed V_{G}. A wind turbine 1 is known to vibrate during its normal operation, and this vibration is known to affect all its elements, including the sensors that it may have, and therefore the measurements taken by said sensors, such that said measurements comprise components relative to said frequencies. Since the natural behavior of the wind turbine 1 is known, it is possible to furthermore identify the origin of the different frequencies resulting from the vibration of the wind turbine 1, i.e., to which part of the wind turbine 1 said vibrations belong.

Ambient temperature and humidity are measured in the method, such that it can be identified whether or not the atmospheric conditions for the generation of ice are met.

The method which is implemented on a blade 10 comprises the following steps, which are carried out in the indicated order:
measuring the angular speed V_{G} of the generator 11 of the wind turbine 1 (of the rotor of the generator 11),
processing said angular speed V_{G} to obtain the frequency spectrum thereof,
identifying a frequency band associated with the frequency characteristic of the blade 10 in said frequency spectrum,
applying a Kalman filter on said frequency band to identify the instantaneous vibration frequency of said blade 10,
comparing said identified instantaneous frequency with a reference frequency that has been previously stored and corresponds with the natural frequency of the blade 10 when there is no ice thereon,
determining the electric power produced by the wind turbine 1, taking the required measurements,
comparing said electric power which has been determined with the estimated electric power to be produced at that time by the wind turbine 1 (the estimated power can be calculated depending on the wind present at the time, for example), and
determining the presence of ice on said blade 10 if the variation between the reference frequency and the identified instantaneous frequency is greater than a predetermined threshold, if the electric power produced is less than the estimated electric power, and if the measured temperature and humidity tend to cause icing.

In the method, these steps are furthermore repeated in a dynamic and cyclical manner, which allows detecting the presence or absence of ice continuously and at all times (in real time).

Therefore, the following three conditions must be met in order to determine the presence of ice on a blade 10:
1. determining a variation between the reference frequency and the identified instantaneous frequency that is greater than the predetermined threshold,
2. detecting a temperature and humidity that tend to cause icing, and
3. determining a produced power that is less than the estimated power to be produced. This condition can be considered as having been met simply if the value of the produced power is less than the estimated power, or if said produced power is less than the estimated power by a given percentage. Setting a percentage greatly assures that the drop-in power is due to the presence of ice (if the two preceding conditions are furthermore met), and not to a mere temporary or instantaneous drop due to other causes. The given percentage depends on the requirements of the plant controller and/or the manufacturer of the wind turbine 1, for example.

As mentioned, the angular speed V_{G} of the generator 11 is detected in real time in the method and said angular speed VG is processed. To that end, a digital signal processing technique which may comprise a band-pass filter, a “Goertzel algorithm”, or a “Goertzel algorithm” mixture, for example, is applied.

Since the natural frequency band corresponding to each of the elements of the wind turbine 1 is known, it is possible to identify the frequency band associated with the blade 10 at hand in a simple manner. By applying a Kalman filter or algorithm on this identified frequency band, the (non-measurable) concealed states of a linear system can be detected for the purpose of increasing the precision of the measurement. The Kalman filter is known, so its operation is not described in detail.

It has been verified that the variation in the frequency of a blade 10 due to the presence of ice is small, so the application of a Kalman filter seems to be highly relevant to enable detecting the presence of ice in a more reliable manner.

The natural frequency in the plane of rotation of the blade 10 is furthermore selected as the reference frequency, this frequency being commonly known as “in-plane” frequency, and being relative to the 3^{rd} component or the 6^{th} component of the fundamental frequency of the angular speed V_{G}, given that it has been verified that these components undergo variations when ice is present on the corresponding blade 10.

Furthermore, the amount of ice built up on the corresponding blade 10 can be determined in the method depending on the deviation of the given instantaneous frequency with respect to the reference frequency. To that end, as many levels of ice as required are previously established, with a given range of frequencies being associated with each of said levels. The selected frequencies are close to one another, such that the presence of ice similarly affects all of them. When ice is present, the corresponding frequency will undergo a variation between 0.01 Hz and 0.1 Hz, so each range will comprise at least a variation of 0.1 Hz between its maximum frequency and minimum frequency. As ice builds up on the blade 10, the rigidity of the blade 10 increases, which causes the natural frequency of the blade 10 in those conditions to decrease. The more ice formed on the blade 10, the higher the rigidity, and therefore the natural frequency, of the blade will be (the more the identified instantaneous frequency decreases, and the deviation therefore increases with respect to the reference frequency), such that when more additional frequencies (more ranges) are selected with respect to the original natural frequency, more information about the ice built up on the blade 10 can be obtained, i.e., the amount of ice present on the blade 10, and not only the presence or absence of ice, can be identified with greater precision. Therefore, as many frequencies as there are levels of ice to be detected on the blade 10 plus one are previously selected, each level of ice being associated with a range of frequencies established between every two selected frequencies and said additional frequency being the selected frequency which corresponds with a natural frequency (reference frequency) of the corresponding blade 10 of the wind turbine 1. In this case, if the presence of ice on the blade 10 is determined through the determination of a variation in the natural frequency (i.e., the identified instantaneous frequency being different from the reference frequency), the range of frequencies to which said identified instantaneous frequency belongs is identified, and the level of ice present on the blade 10 is determined depending on said identification.

A second aspect of the present invention relates to an ice detection system for a wind turbine comprising a plurality of blades 10 and a generator 11, where said system is adapted for supporting the method of the first aspect of the present invention in any of its embodiments.

The system comprises a detector (not depicted in the drawing) for detecting the angular speed V_{G} of the generator 11, and a controller (not depicted in the drawing) which is communicated with said detector for receiving said detection and is configured for implementing the method of the first aspect of the present invention taking into account said detection. The controller is therefore configured for implementing the filters used and for performing the steps mentioned for the first aspect of the present invention based on the detection of the angular speed V_{G} it receives.

The system further comprises a memory with the previously stored reference frequency value, as well as the value of the rest of the selected frequencies, where appropriate, and with the levels of ice associated with each of the ranges of frequencies generated based on said stored frequencies, where said memory can be integrated in the controller or can be an independent element.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

What is claimed:

1. An ice detection method for a wind turbine, the wind turbine comprising a plurality of blades and a generator, wherein the method is carried out for a blade and including measuring ambient temperature and ambient humidity, the method comprising the following steps carried out in that order in a dynamic and cyclical manner:
measuring an angular speed of the generator of the wind turbine;
processing the angular speed to obtain a frequency spectrum thereof;
identifying a frequency band associated with a frequency characteristic of the blade in the frequency spectrum;
applying a Kalman filter on frequency band to identify an instantaneous vibration frequency of the blade;
comparing the identified instantaneous frequency with a reference frequency that has been previously stored, and which corresponds with the natural frequency of the blade when there is no ice thereon;
determining an electric power produced by the wind turbine;
comparing the electric power which has been determined with an estimated electric power; and
determining a presence of ice on the blade if the identified instantaneous frequency differs from the reference frequency, if it is detected that the electric power which has been determined is less than the estimated electric power, and if the measured temperature and humidity tend to cause icing.

2. The method according to claim 1, wherein the presence of ice on the blade is determined if the difference between the identified instantaneous frequency and the reference frequency is greater than a given threshold.

3. The method according to claim 2, wherein as many frequencies as there are levels of ice to be detected on the blade plus one are previously selected, each level of ice being associated with a range of frequencies demarcated between every two of the selected frequencies and the additional frequency being the selected frequency which corresponds with a natural frequency or reference frequency of the corresponding blade of the wind turbine, and wherein if the presence of ice on the blade is determined, the identified instantaneous frequency is compared with the selected frequencies and the range of frequencies to which it belongs is determined, the level of ice associated with said given range of frequencies being determined as the level of ice present on the blade.

4. The method according to claim 3, wherein the natural frequency of the selected corresponding blade is far enough away from the frequencies generated by the rotation of the generator to prevent the natural frequency from being affected by the resonances of the generator.

5. The method according to claim 4, wherein the natural frequency of the selected blade corresponds with the 3^{rd} component or the 6^{th} component of the natural in-plane frequency of the corresponding blade.

6. The method according to claim 1, wherein all the selected frequencies are close to one another, the frequency spacing between two selected adjacent frequencies being 0.1 Hz and the minimum frequency spacing between two selected adjacent frequencies being 0.01 Hz.

7. The method according to claim 1, which is carried out for each of the blades of the wind turbine.

8. An ice detection system for a wind turbine, the wind turbine comprising a plurality of blades and a generator, is the ice detection adapted for supporting the method according to claim 1.

9. The system according to claim 8, comprising a detector for detecting the angular speed of the generator of the wind turbine and a controller communicated with said detector, the controller being configured for implementing the method according to claim 1 depending on the detection.

10. The system according to claim 1, comprising at least one memory with the value of the previously stored frequencies required for implementing the method.
